(19) United States
(12) Patent Application Publication
(10) Pub. No.: US 2006/0014032 A1
(43) Pub. Date: Jan. 19, 2006

(54) Thermal spray coating process and thermal spray coating materials

(76) Inventors: Florian Lampmann, Neu-Ulm (DE); Torsten Wittrowski, Ulm (DE)

Correspondence Address: PENDORF & CUTLIFF, 5111 MEMORIAL HIGHWAY, TAMPA, FL, 33634-7356, US

(21) Appl. No.: 11/183,507

(22) Filed: Jul. 18, 2005

(30) Foreign Application Priority Data
Jul. 16, 2004 (DE) 10 2004 034 575.9
Aug. 20, 2004 (DE) 10 2004 040 460.7

(51) Int. Cl. B32B 15/04

(52) U.S. Cl. 428/469; 428/937; 428/701; 428/702; 428/632; 427/446

(57) ABSTRACT

Process for arc wire spraying for depositing material layers, in particular slide bearing layers, wherein at least one oxygen containing atomizing gas and one fuel gas are supplied to the spray device, which are combusted in a burn chamber in the immediate vicinity or behind the arc under the influence of a part of the oxygen containing atomizing gas and following the exit from the nozzle a flame jet or spout produces wherein that by the oxidation of the metallic components of the spray wire a metal oxide layer is formed at least on the outer surface of the spray droplets, as well as material layers, in particular bearing layers, of Cu-containing alloys with metal oxide microstructure segregated areas, wherein the material exhibits a lamella like microstructure of thicker lamellas of Cu-alloys and thinner lamellas of metal oxide, wherein the lamellas are oriented primarily parallel to the substrate of the base material.

### BACKGROUND OF THE INVENTION

1. Field of the Invention

The subject of the invention is thermal spray coating, by means of a modified arc wire spray process (LDS), of metallic, Cu-containing coatings on surfaces, in particular on metallic surfaces, for production of slide (bearing) layers. This type of coating is primarily employed in order to increase the mechanical and/or tribologic load bearing capacity or toughness of the surface, in particular its solidity, hardness and wear resistance. Depending upon the material of the coating and the surface to be coated, the quality of the adhesion may vary, in particular the adhesive peel resistance between layer and substrate. For example, thermal deposited Cu-alloys on Fe-based surfaces, such as steel, have an insufficient adhesion and in particular have insufficient hardness when used as a slide bearing layer.

2. Related Art of the Invention

Arc wire spraying (LDS) is well suited for mass production of metallic layers due to it's high process stability and high application speeds.

One known solution of the problem of insufficient adhesion strength involves the application of adhesion promoting immediate layers, wherein graded layers appear to be of particular interest.

According to WO 95 12473 A a layer with a gradient can be produced with local varying mechanical characteristics, in that two different material sprays are simultaneously applied overlapping, however, with varying intensity, upon the surface to be coated. This is associated with a comparatively high apparatus cost.

According to DE 697 02 576 T2 a gradient layer with local varying mechanical characteristics can be produced in that the composition of the atomized gas is changed, with respect to inert and oxidizing components, during thermal spray application.

One disadvantage in the production of intermediate layers and gradient layers is the higher process cost and the higher layer thickness of the total coating.

From DE 100 35 032 A1 a process for production of a piston rod with a bearing layer is known, wherein the bearing layer is applied preferably by means of thermal spray processes, in particular plasma spraying or arc wire spraying, and preferably is comprised of Al/Cu-alloys or Cu/(Zn, Al, Sn)-alloys.

From DE 100 35 031 A1 slide bearing layers are known likewise obtained by thermal spraying. Therein the slide bearing layers exhibit a gradual change in the composition of the coating with increasing layer thickness. The coating is preferably comprised of mainly Cu/Al-alloys close to the substrate and exhibits an increasing component of titanium oxide further from the substrate.

From EP 1 003 924 B1 thermal spray applied slide bearing layers of bearing metal or Babbitt metal are known. Therein the layer should exhibit an increased porosity at least in the upper area, in order to form open micropores as micropockets for the lubricant or slide agent. In a preferred process variant oxidation locks produced by partial oxidation of the sprayed material are separated off or removed in the layer, and are again emptied by surface follow up processing with formation of free micropores.

The formed bearing layers as a rule do not exhibit the necessary hardness and wear resistance.

### SUMMARY OF THE INVENTION

It is thus the task of the invention to provide a thermal spray process, with which hard material layers can be deposited with good adhesion and, as well, to provide material layers, which are suited as tribologic bearing layers with high load bearing capacity.

The task of the invention is solved by a process for arc wire spray coating to deposit material layers, wherein a spray device is supplied with at least one oxygen containing atomizing gas and a fuel gas, which burns in a combustion chamber in the immediate proximity of or subsequent to the arc wire under the influence of a part of the oxygen containing atomizing gas and, following the exit from the nozzle, produces a flame spray or jet, with the characterizing features of claim 1, as well as a material layer, in particular a (slide) bearing layer, of Cu containing alloys with a metal oxide microstructure with exclusions or segregated zones, with the characterizing features of claim 12. Preferred further developments are the subject of the dependent claims.

The inventive process is referred to in the following as the LDS hybrid process.

The process and the material layer will now be described on the basis of the figures. Therein a comparison is shown of results obtained with the inventive LDS hybrid and with the conventional LDS process. For comparative purposes both processes are carried out using the same equipment. Therein essentially an operation with and an operation without fuel gas are contrasted.

### BRIEF DESCRIPTION OF THE DRAWINGS

Therein there is shown:

FIG. 1 Schematic diagram of an LDS hybrid burner, with wire 1, wire advance 2, contact producing wire guide 3, combustion gas mixture 4, atomizing gas 5, combustion chamber 6, arc 7, fuel gas flame 8, and spray stream 9.

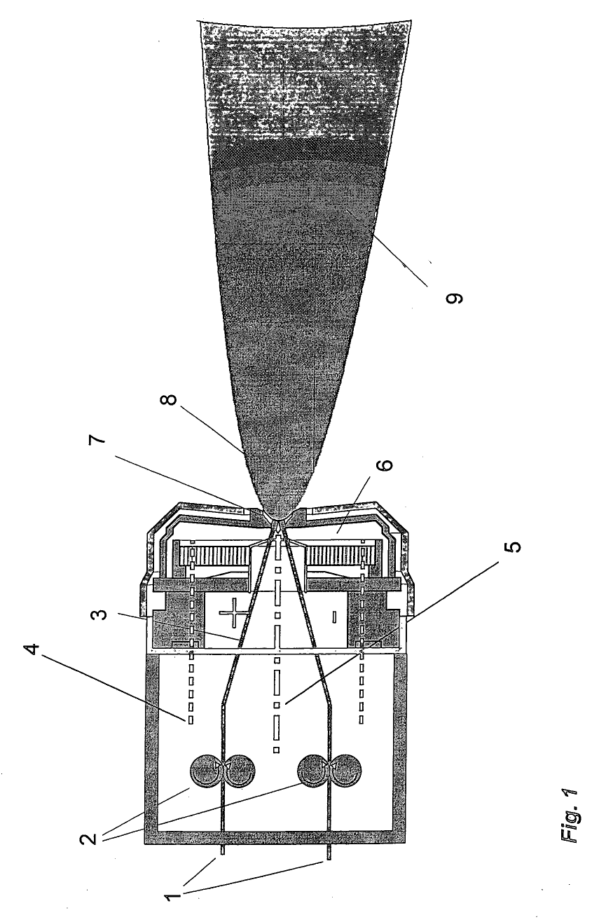

FIG. 2 Comparison of the particle speed for LDS hybrid process and conventional LDS process, depending upon the current strength.

FIG. 3 Comparison of the particle diameter for LDS hybrid process and conventional LDS process, depending upon current strength.

FIG. 4 Comparison of the volume streams for LDS hybrid process and conventional LDS process, depending upon the atomizing gas pressure.

FIG. 5 Brass layer sprayed by means of LDS hybrid process with oxide layer (lamella) (10), metal layer (11) and pore (12).

### DETAILED DESCRIPTION OF THE INVENTION

In the inventive process an arc wire spray process (LDS) is provided, in which the spray process, or as the case may be spray pistol, is supplied with at least one oxygen-containing atomizing gas and a fuel gas. The oxygen-containing atomizing gas 5 is divided into two volume streams, wherein one stream is mixed with the fuel gas to form a combustion gas mixture 4 and directly supplied to the combustion chamber 6. The other stream is, as a rule, the main stream, which is supplied bypassing the ignition point of the combustion chamber. Both streams are merged behind the ignition point in the combustion chamber. The combustion gas is ignited in a combustion chamber 6 in the direct vicinity of, or subsequent to, the arc 7 between the wires 1. Thereupon the gas streams are again merged and produce, following the exiting from the nozzle, a combustion gas flame 8 or flame stream. The combination of the conventional LDS process and the ignition of a fuel gas are referred to in the following as hybrid LDS process.

One advantage of the hybrid LDS process is that, by the combustion, supplemental energy is input into the spray material, and that the spray material is supplementally accelerated. The acceleration results in particular from the volumetric expansion of the combustion gas in the combustion chamber. Besides the acceleration of the spray particles, the combustion, in the hybrid process, brings about among other things also a higher degree of atomization or, as the case may be, size reduction of the spray particles.

A characteristic of the inventive hybrid LDS process is that the gas atmosphere, which surrounds the spray particles in the burn chamber and/or the spray nozzle, depending upon oxygen content of the combustion mixture of fuel gas and atomizing gas, can be an oxidizing gas.

In accordance with the invention it is provided that oxidizing conditions are established, so that by the oxidation of the metallic components of the spray wire or, as the case may be spray material, a metallic oxide layer is formed at least on the surface of the spray drops. The amount of the formed oxide is variable depending upon the process parameters of the hybrid LDS process. It is however important for the inventive process that the neither the entire spray particles nor individual spray particles need be completely oxidized throughout. Rather, the spray particles are only partially oxidized, wherein the formed oxides remain bonded upon the spray particles. The thus formed spray particles produce, in combination with the high spray speeds and the fine spray particles, a characteristic microstructure in the deposited layer.

One advantage of the inventive process is that the therewith obtainable layers, in comparison to the conventional spray processes, in particular the conventional LDS process, exhibit a higher hardness and improved adhesion strength.

The amount of the formed metal oxide is, among other things, dependent upon the oxygen content of the gas surrounding the spray material, as well as the chemical composition of the spray material itself.

In accordance with the invention it is provided that the amount of the formed metal oxide is adjusted to be 1-9 wt. % of the metallic components of the original employed spray wire. It is particularly preferred when the amount is in the range of 2 to 5 wt. %. Preferably the oxidation of the metallic components of the spray material is so adjusted, that the spray particles are completely covered by an oxide layer. The oxide layer thereby lies typically in the range of 100 nm to 2 μm. Preferably the metallic components are so selected, that the oxide forms a layer-like crystal structure.

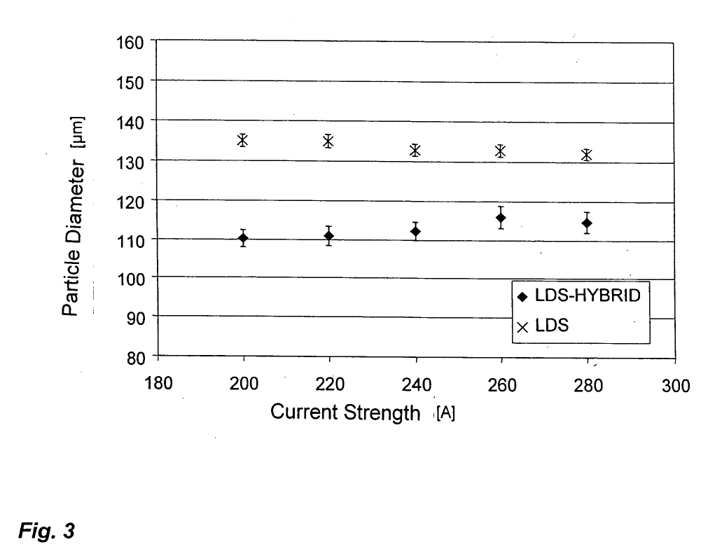

For the layers obtainable in accordance with the inventive process the fine microstructure is advantageous in particular in order to achieve high stability or solidity. Preferably, for the average particle size of the formed spray particles, a value of less than 150 μm is selected. The average particle size can be adjusted to the desired range by adjusting the process parameters, in particular the through-put in atomizing gas or spray pressure, arc power and spray gas. FIG. 3 shows a range of particle sizes typically achievable by the inventive process. In comparison, the particle sizes produced with the LDS process with otherwise conventional process parameters is shown. The average particle size preferably lies in the range of 10 to 200 μm, particularly preferably to 20 to 120 μm. If the particles are too small they exhibit, on the basis of their high relative outer surface area, the disadvantages effect of a too high degree of oxidation. Therein the through-oxidation of individual particles can be prevented only with difficult.

In accordance with the invention it is provided that in the combustion chamber a mixture of oxidizable atomizing gas and a fuel gas are converted. Preferably the atomizing gas is selected to be air and the fuel gas is selected to be carbohydrate or, as the case may be, a carbohydrate mixture. For the preferred carbohydrates there can be selected alkanes, in particular methane or ethane, as well as natural gas. Further also unsaturated carbohydrates can be employed, in particular ethene or acetylene.

In the selection of the mixture ratio of oxidizing atomizing gas and fuel gas it is to be observed that an excess stochemetric air/carbohydrate mixture is to be adjusted to. Thereby it is achieved, that the inventive partial oxidation of metallic components of the spray material can occur. In the combustion chamber preferably a gas mixture with an air/carbohydrate relationship (Lambda-value) above 1.15 is adjusted. With this value an oxidizing atmosphere is ensured.

The process parameters are preferably so adjusted, that 1-15 wt. % of the metallic components of the original employed or introduced spray material are converted to metal oxide. Therein the amount of the formed metal oxide as a rule does not correspond to the amount of the metal oxide phases later detectable in the layer.

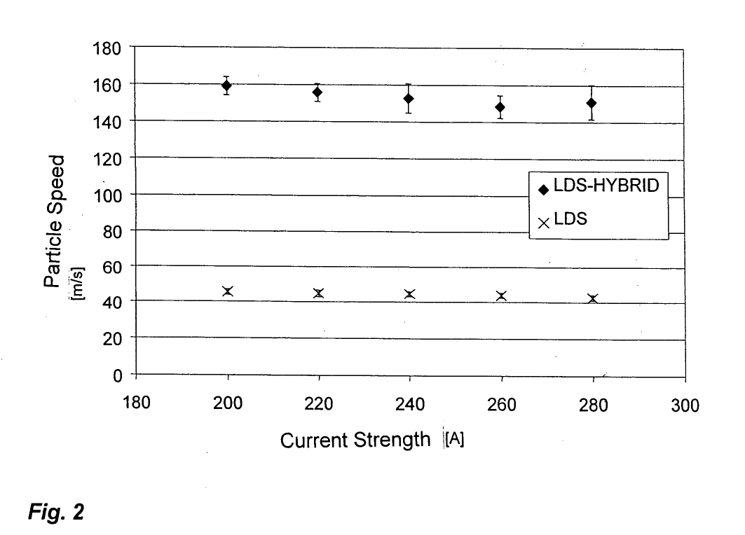

The inventive process is characterized by comparatively high particle speeds in the spray gas. Thereby it is possible to form qualitatively high value layers with low porosity. FIG. 2 shows a range of particle speeds typically achievable in the inventive process. For comparison, the particle speeds resulting with the otherwise conventional process parameters with LDS processes are shown. Preferably the spray stream is so selected, that the speed of the spray droplets in the spray stream are above 70 m/s. It is particularly preferred to adjust the particle speeds to above 90 and even more preferably above 150 m/s. The changes of the current strength have only a small influence on these values.

Surprisingly it has been found that the particle temperature with LDS hybrid processes are comparatively lower than with LDS processes with otherwise the same process parameters. The change in the flow strength have only a small influence on the measured value.

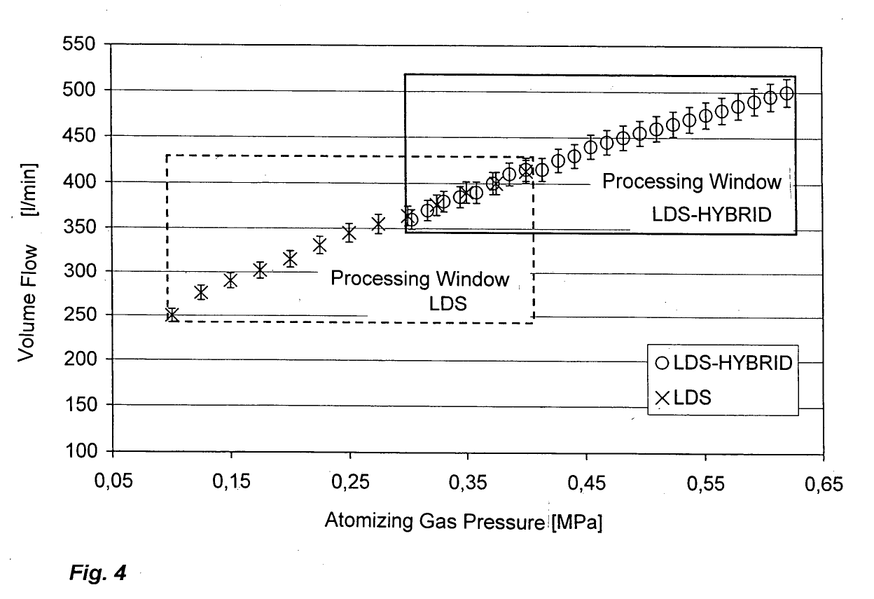

FIG. 4 shows a range of volume streams typically achievable with the inventive process depending upon atomizing gas pressure. For comparison, the volume streams obtained using otherwise conventional process parameters in the LDS process are shown. Preferred is the volume stream in which the carrier gas leaving the spray pistol is adjusted to a value above 450 l/min. The pressure range of the atomizing gas therefore typically necessary lies above 0.4 bar. Preferably the volume streams are adjusted above 500 l/min, wherein therefore gas pressures above 0.55 bar are needed.

For the formation of a layer with fine lamella microstructure and low component of faults, a low current strength, low voltage and high gas pressure or as the case may be a higher volume stream is preferred.

In the inventive LDS process the hot combustion gasses comprising fuel gas and oxygen-containing atomizing gas (fuel gas mixture) are reunited subsequent to the ignition point in the combustion chamber with the cold air stream of the residual atomizing gas, the main stream of the atomizing gas. On the basis of the very diverse pressure relationships of main stream of the atomizing gas with a high pressure and tight or narrow stream, and the fuel gas with low pressure and wide stream, the mixture at this point is still very incomplete. The fuel gasses are mixed-in from around the outside with the atomizing gas. Beginning with the exit opening of the nozzle a turbulence-free jet stream is formed, of which the core zone is in the form of a flame jet stream. There, in general, no significant mixing-through with the environment air takes place. The length of the flame stream is dependent, among other things, upon nozzle cross-section. Preferably the length of the flame stream is adjusted to be at least 30 nm.

The formation of the inventive fine lamella microstructure is dependent among other things upon the selected spray material.

Therein it is of great significance or importance, that suitable metal oxides can be formed, which can again be found in the microstructure of the deposited layer, that is, in the lamellar structure. Preferred are thus sprayed materials from the material classes of Cu-bronzes or Babbitt material. These include Cu, however also Zn or Sn materials for forming the suitable oxide. As spray material there are employed in a preferred variant of the inventive process a spray wire with a Cu-alloy. Particularly preferred are two spray wires of the same composition and thickness.

In a further variant two different spray wires with different composition are employed. Therein the composition is so selected, that in the spray droplets a Cu-alloy is formed.

The process is suited for the depositing of thin layers as well as for the depositing of thick layers. Preferred are however the depositing of thin layers, since here the advantage of the inventive process is particularly noticeable. Preferred material layer thicknesses are in the range of 20 to 500 μm, particularly preferred is the range of 40 to 80 μm.

The process is very suited for production of slide bearing layers of bearing materials, in particular of Cu-containing bearing materials. Thus the process is very suited for example for replacing a bearing shell for a piston rod produced as a separate subcomponent with a slide bearing layer sprayed directly onto the piston rod surface.

A further aspect of the invention concerns a material layer of Cu-containing alloys with oxidized microstructure segregation or deposits.

These material layers are comprised in particular of bearing metals and are preferably employed as bearing layer in motor construction. For example, these material layers can be employed as bearing layers in high load bearing piston rods of diesel engines, where these can replace the conventionally produced composite piston rod.

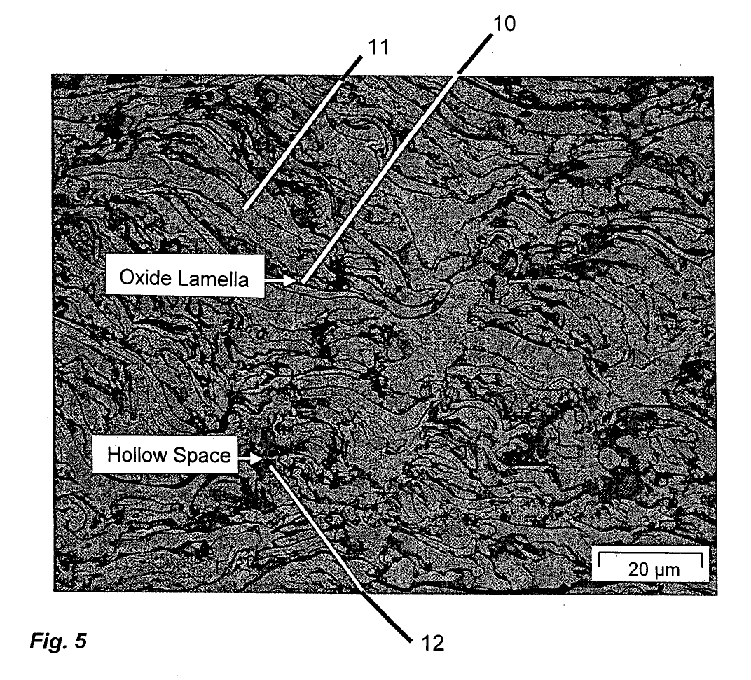

In accordance with the invention it is provided that the material exhibits a lamella like microstructure of thicker lamellas of Cu-alloys and thinner lamellas of metal oxide, wherein the lamellas are oriented primarily parallel to the substrate of the base material. Therein the microstructures are characterized by a comparatively fine lamellar buildup. FIG. 5 shows the sectional image of an inventive brass layer, FIG. 6 shows the cut image of an inventive bronze layer. The figures serve for illustrating the invention and are in no way intended to be considered as limitations.

In contrast to many conventional thermal spray processes, the entire microstructure is essentially built up of lamella. This means, that only a comparatively small proportion of the microstructure phases are in globular or grain shape. Rather, primarily flat, platelet-like layers or foil-like phases are formed, which are represented by the oxide lamella 10 and metal lamella 11 of FIGS. 5 and 6. These structures concern in particular the metal oxides. It is preferred when the proportion of the present crystal metal oxides not in the form of layers or lamellas are less than 15% of the amount of the metal oxides of the material. A further proportion of metal oxides lie distributed nanodisperse in the metal phases. By a fine lamellar structure, among other things a comparatively long contact surface between the phases of metal oxide and the metallic phases of the microstructure are formed. In particular, by the combination of lamellar buildup and large contact surfaces between metal oxide and metal phases, a high mechanical reinforcement effect is achieved in the material. It is in principle known that deposit segregation or exclusion is supplementally strengthened by a microstructure morphology such as that produced using the present invention. It is particularly preferred therein, that the strengthening does not lead to an undesired increase in roughness or brittleness. The material layers deposited in accordance with the inventive process show a comparatively better tensile strength than layers deposited with conventional LDS.

The average thickness of the lamella of a Cu-alloy in the inventive layer material lies as a rule below 50 μm. It is preferred when very fine lamella are formed, of which the thickness lies in the average of less than 20 μm. In order to form the inventive platelets of lamella shapes the metal phases exhibit an average breadth or width which represents at least a two-fold of the thickness. This means, an aspect ratio of greater than 2. The average breadth of the lamellas of Cu-alloys therein lies preferably below 500 μm and particularly preferredly below 100 μm.

The metal oxide lamella are correspondingly thinner, typically below an average thickness of 5 μm, wherein the breadth is not substantially less than that of the metal phases. The metal oxide phases exhibit therewith an aspect ratio significantly above 2.

Therein the amount of the metal oxide contained in the material layer exhibits an important influence upon the material characteristics. Preferably the content of the metal oxides lies below 10 wt. % of the amount of the metallic phases of the material layer, particularly preferred is the range of 0.1 to 5 wt. %. It is particularly preferred when the metal oxide component lies, expressed in terms of oxygen content, at 0.2 to 1 wt. % based upon the layer material.

In the material layers deposited by the inventive LDS hybrid process the metal oxide component lies as a rule at 1-9 wt. % of the metallic component of the original employed spray material.

The particularly suitable Cu-alloys include bronze and brass. Preferred is a bronze with 4 to 8 wt. % Sn and 0.5 to 2 wt. % Ag and a brass with 1.5 to 6% Zn and 0.5 to 2% Si. Particularly preferred are CuZn₃₁Si₁ and CuSn₆Ag₁.

The copper alloys are preferably so selected, that in the layer materials the metal oxide lamellas are primarily formed by Cu(I)- or Cu(II)-oxide. The oxides crystallized in the layer structures exhibit a desirable effect upon the formation of a high fracture toughness.

The inventive material is also characterized by a low porosity. Although a high surface porosity in the area of the slide bearing layers is desirable for reasons including the formation of micro-slide lubricant pockets, the porosity fundamentally leads to worse mechanical characteristics. Preferably the porosity of the material thus lies below 5%, particularly preferred below 1.5%.

Besides the good solidity and fracture toughness a further advantage of the inventive material is its good adhesiveness to metallic substrates. Thus, the material layer is preferably applied directly, without intermediate layers, upon the metallic substrate.

Therein it is advantageous to condition the substrate surface. This can occur for example by roughening using sandblasting, preferably by means of water jets or, as the case may be, high pressure water jets. It is likewise possible to provide a roughening by chemical or electrochemical processes.

A further possibility for conditioning involves application of adhesive layers. For this, there are particularly suited brass or bronze material systems conventionally employed in this art as intermediate layers.

The preferred uses of the inventive material layer include the formation of a slide bearing surface. Therein the material layers are advantageous in particular in motor construction. The particularly preferred applications include slide bearings in connecting rods, such as for example those employed in automobile motor construction.

### EXAMPLE 1

For a brass layer, the inventive LDS hybrid process and the conventional LDS process are compared with each other. In order to be able to compare the tested processes with each other, a standard set of parameters is defined in which all process variants, with and without fuel gas, can be stably carried out. The parameters thus do not necessarily represent optimal values for the inventive process.

As standard parameters, there are selected:
Current strength: 150 A
Voltage: 35V
Atomization Gas Pressure: 0.4 MPa
Pressure Relationship of Fuel Gas/oxidizing Atomizing Gas (Lambda value): 1.22 (for the conventional LDS process nitrogen is selected as the atomizing gas)
Substrate material: Forged steel
Conditioning of the surface is by high pressure water jets

As fuel gas, methane was selected; as oxidizing atomizing gas, air was selected.

Results of Comparison for Brass

| | | | | Oxygen |
|---|---|---|---|---|
| | | Density of | | Content in |
| | Particle | the layer | Roughness R_{z} | the layer |
| | Speed (m/s) | (g/ccm) | (μm) | (%) |
| Conventional | 77 | 7.43 | 71 | 0.06 |
| LDS | | | | |
| Hybrid LDS | 93 | 7.53 | 56 | 0.29 |

It can already be seen in the carried out standard parameters, that the particle speed with LDS hybrid processes are greater than with comparative processes.

The density also of the material layer formed with the inventive process lies significantly higher than with the comparative process. This indicates the presence of more dense layers with a more homogenous microstructure.

The surface roughness (R_{z}) with the inventive process lies significantly below that with the roughness achieved with the comparative process. This provides a simplification of the follow up processing of the sprayed layers and is likewise indication for the fine microstructure.

The oxygen content of the LDS-hybrid layer is close to four times as high as that of the comparative layer.

Depending upon the process, the brass layers are comprised in large part of alpha brass with the approximate composition Cu₃Zn. The LDS hybrid sprayed layer in addition exhibits smaller amounts of well crystallized Cu. As metal oxide, there can be found in particular ZnO.

Comparative Results with Brass

| | Hardness | Bend Strength | Adhesiveness |
|---|---|---|---|
| | HV 0.1) | (MPA) | (MPa) |
| Conventional | 108 | 177 | 38 |
| LDS | | | |
| Hybrid LDS | 131 | 260 | 56 |

It can be seen that, already in the comparative parameter set, significantly improved values for hardness, bend strength and adhesion strength can be observed for the inventive LDS hybrid process. With optimal process parameters for the LDS hybrid layers bend or flexural strengths of up to 360 MPa can be produced.

With an optimal parameter set for atomizing gas pressure of 0.62 MPa, current strength 180 A, voltage 45 V and pressure relationship (lambda-value) 1.28 there can in the LDS hybrid process at a thickness of 690 μm a rigidity of 340 MPa, adhesion peel resistance of 46 MPa, hardness of 150 HV 0.1, porosity of 0.72% and roughness of 27 μm.

### EXAMPLE 2

For a bronze layer the inventive LDS hybrid process and the conventional LDS process were compared with each other.

In order to be able to compare the examined processes with each other, just as in Example 1 a defined set of standard parameters was selected. The parameters thus do not represent the optimal values for the inventive process.

As fuel gas, methane was selected; and as oxidizing atomizing gas, air was selected.

Comparative Results with Bronze

| | | | | Oxygen |
|---|---|---|---|---|
| | | Density of | | Content in |
| | Particle | the layer | Roughness R_{z} | the layer |
| | Speed (m/s) | (g/ccm) | (μm) | (%) |
| Conventional | 85 | 7.7 | 62.5 | 0.4 |
| LDS | | | | |
| Hybrid LDS | 107 | 7.96 | 87.4 | 1.2 |

It can already be seen in the carried out standard parameters that the particle speed with the LDS hybrid process is significantly greater than with the comparison process. Also, the density of the formed material layer in the case of the inventive process is significantly higher than with the comparative process. This indicates more dense layers with more homogenous microstructures.

The surface roughness (R_{z}) lies in the inventive process significantly below that of the comparative test. The oxygen content of the LDS hybrid layer is close to 3 times as high as that of the comparative layer.

Comparative Results with Bronze

| | Hardness | Bend Strength | Adhesiveness |
|---|---|---|---|
| | HV 0.1) | (MPA) | (MPa) |
| Conventional | 116 | 386 | 23 |
| LDS | | | |
| Hybrid LDS | 155 | 502 | 29 |

Also with the bronze layer with the comparative parameter set, it is clear that significantly improved values can be observed for hardness, bending strength and adhesion strength for the inventive LDS hybrid process. With optimal process parameters a bend stiffness (flexural strength) of up to 580 MPa can be produced for the LDS hybrid layers. These are achieved using lower voltage, higher atomization pressure and high pressure ratio.

1. A process for arc wire spraying for depositing material layers, in particular slide bearing layers, comprising:
supplying as combustion gas at least one oxygen containing atomizing gas and one fuel gas to a flame spray device, the flame spray device including means for advancing a wire, means for producing an arc, and a nozzle for directing gas,
burning the combustion gas in a burn chamber in the immediate vicinity of or downstream of the arc under the influence of a part of the oxygen containing atomizing gas and producing following the exit from the nozzle a flame jet,
wherein by the oxidation of the metallic components of the spray wire a metal oxide layer is formed at least on the outer surface of the spray droplets.

2. The process according to claim 1, wherein the amount of the formed metal oxide lies at 1-9 wt. % of the metallic components of the originally employed sprayed wire.

3. The process according to claim 1, wherein the average of the particle size of the formed spray particles lies below 150 μm.

4. The process according to claim 1, wherein the average particle size of the formed spray particles lies in the range of 20-120 μm.

5. The process according to claim 1, wherein the atomizing gas is air and the fuel gas is a carbohydrate, wherein in the burning chamber a gas mixture with excess stochiometric air/carbohydrate relationship above 1.15 is formed.

6. The process according to claim 1, wherein 1-15 wt. % of the metallic components of the originally employed spray material are converted to metal oxide.

7. The process according to claim 1, wherein the speed of the sprayed droplets in the spray stream are above 70 m/s.

8. The process according to claim 1, wherein the volume stream of the carrier gas leaving the spray device is greater than 450 l/min.

9. The process according to claim 1, wherein the flame jet exhibits a length of at least 30 mm.

10. The process according to claim 1, wherein two spray wires of the same Cu-alloy are selected, or with different compositions which form a Cu-alloy in the spray droplets.

11. The process according to claim 1, wherein the depositing results in a material layer thickness of 40 to 80 μm.

12. A material layer, in particular slide bearing layer of Cu-containing alloys with metal-oxide microstructure exclusions or segregations or discrete regions containing alloys, wherein the material includes a lamella like microstructure of thicker lamellas of Cu-alloys and thinner lamellas of metal oxide, wherein the lamellas are oriented primarily parallel to the substrate of the material layer.

13. The material layer according to claim 12, wherein the proportion of the crystalline metal oxide not present in the layer or lamella shape is less than 15% of the amount of the metal oxide.

14. The material layer according to claim 12, wherein the average thickness of the lamella of Cu-alloy is less than 20 μm.

15. The material layer according to claim 12, wherein the average breadth of the lamellas of Cu-alloys is less than 100 μm.

16. The material layer according to claim 12, wherein the proportion of the metal oxide is in the range of 0.1 to 5 wt. % of the material layer.

17. The material layer according to claim 12, wherein the Cu alloy is bronze with 4 to 8 wt. % Sn and 0.5 to 2 wt. % Ag or brass with 1.5 to 6% Zn and 0.5 to 2% Si.

18. The material layer according to claim 12, wherein the metal oxide layers are primarily formed by Cu (I)- or Cu (II)-oxide.

19. The material layer according to claim 12, wherein the porosity lies below 1.5%.

20. The material layer according to claim 12, wherein the material layer is directly and without intermediate layer applied upon the metallic substrate.

21. A connecting rod or piston rod with a slide bearing layer of Cu-containing alloys with metal-oxide microstructure exclusions or segregations or discrete regions containing alloys, wherein the material includes a lamella like microstructure of thicker lamellas of Cu-alloys and thinner lamellas of metal oxide, wherein the lamellas are oriented primarily parallel to the substrate of the material layer.
